(19) United States
(12) Patent Application Publication
(10) Pub. No.: US 2025/0239899 A1
(43) Pub. Date: Jul. 24, 2025

(54) ELECTRIC ROTARY MACHINE HAVING A VIBRATION DAMPENING AND COOLING STATOR SLEEVE

(71) Applicant: Valeo eAutomotive Germany GmbH, Erlangen (DE)

(72) Inventors: Christian MEDING, Erlangen (DE); Parag PATIL, Erlangen (DE)

(73) Assignee: Valeo eAutomotive Germany GmbH, Erlangen (DE)

(21) Appl. No.: 19/034,032

(22) Filed: Jan. 22, 2025

(30) Foreign Application Priority Data
Jan. 22, 2024 (DE) 102024101791.0

(51) Int. Cl. H02K 1/18; H02K 1/20; H02K 9/19

(52) U.S. Cl. CPC H02K 1/185; H02K 1/20; H02K 9/19

(57) ABSTRACT

An electric rotary machine for an automotive vehicle includes a rotor which is non-rotatably connected to a rotor shaft, and a stator which surrounds the rotor. A casing encloses the rotor and stator, the rotor shaft being rotatably mounted on the casing along an X axis. A stator is carried by the casing, and a stator sleeve is radially arranged between an outer surface of the stator and an inner cylindrical surface of the casing. The stator sleeve is made of an elastic material and is arranged to filter vibrations generated by the stator and resulting from electromagnetic forces present in the stator when the electric rotary machine is in operation. The stator sleeve includes a cooling groove which is intended to be connected to a coolant supply line.

### TECHNICAL FIELD

The invention relates to the field of electric rotary machine for an automotive vehicle.

### TECHNOLOGICAL BACKGROUND

US2019/0305615 discloses an electric rotary machine comprising a rotor, a stator, and a casing in which the rotor and the stator are enclosed. The stator comprises windings and an iron core into which the windings are inserted. The stator is held to the casing tanks to a stator sleeve which is radially arranged between the iron core and the casing. The stator sleeve includes a cooling groove which is arranged on its outer circumference. As a result, a flow path through which a coolant can flow is formed between the outer circumferential surface of the stator sleeve and the inner circumferential surface of the casing. Thus, the stator sleeve includes a heat-dissipation function.

Such rotary electric machine is not completely satisfactory. The electromagnetic forces present in the stator when the electric rotary machine is in operation lead to high vibrational excitation of the whole casing. Therefore, high levels of noises and vibrations are measured on the outside of the casing.

### SUMMARY

One underlying concept of the invention is therefore to propose an electric rotary machine which have both good heat dissipation and vibration dampening properties.

For this purpose, according to one embodiment, the invention provides an electric rotary machine for an automotive vehicle comprising:
a rotor which is non-rotatably connected to a rotor shaft,
a stator which surrounds the rotor;
a casing in which the rotor and the stator are enclosed, the rotor shaft being rotatably mounted on the casing along an X axis; and
a stator sleeve which is enclosed in the casing and is radially arranged between an outer surface of the stator and an inner cylindrical surface of the casing;
wherein the stator sleeve is made of an elastic material and is arranged to filter vibrations which are generated by the stator and result from electromagnetic forces present in the stator when the electric rotary machine is in operation; and wherein the stator sleeve comprises a cooling groove which is intended to be connected to a coolant supply line.

Thus, such a stator sleeve has a dual function, i.e., dampening the vibrations and cooling the stator. This gives easily the rotary electric machine good heat dissipation and vibration dampening properties.

Depending on the embodiments, such an electric rotary machine may have one or more of the following features.

According to one embodiment, the cooling groove is helicoidal around the X axis and is arranged on a radially inner surface of the stator so that a flow path having a spiral shape is formed between the radially inner surface of the stator sleeve and the outer surface of the stator. This further improves the heat-dissipation performances of the stator sleeve.

According to one embodiment, the casing comprises a supply port which communicates with a first end of the cooling groove.

According to one embodiment, the coolant supply line is filled with a coolant which is a dielectric fluid, such as oil.

According to one embodiment, the elastic material is an elastomeric material such as natural or synthetic rubber.

Such material has good vibration-filtering properties and is also much lighter than the aluminum usually used to manufacture the stator sleeve, thus reducing the weight of the whole rotating electric machine.

According to one embodiment, the elastic material has a young modulus which is comprised between 0.001 and 0.1 GPa.

According to one embodiment, the casing includes two opposing faces which are orthogonal to the X axis and are joined together by a cylindrical skirt which extends around the X axis.

According to one embodiment, the stator is bolted to one of the two opposing faces of the casing by means of screws which extend parallel to the X axis and each pass through a corresponding hole arranged in the stator.

According to one embodiment, the stator sleeve is pressed against at least one of the opposing faces of the casing.

According to one embodiment, the stator sleeve is pressed against each of the two opposing faces of the casing.

According to one embodiment, the casing includes at least two components which each comprise a flanged end, the flanged ends of the two components being attached to each other.

According to one embodiment, the stator sleeve comprises a radial flange which is axially arranged between the two flanged ends.

According to one embodiment, the stator sleeve includes metallic inserts which are embedded in the elastic material.

According to one embodiment, the stator comprises windings and an iron core which carries the windings.

According to one embodiment, the iron core comprises a plurality of ducts which are arranged to conduct the coolant from the cooling groove to the windings. This further improves the cooling performances.

According to one embodiment, the invention also provides an automotive vehicle comprising the aforesaid electric rotary machine.

### BRIEF DESCRIPTION OF THE FIGURES

The invention will be understood better, and further objects, details, characteristics, and advantages thereof will become clearer during the following description of several embodiments of the invention, which are given only by way of illustration and without limitation, with reference to the appended drawings.

FIG. 1 is a schematic cross-sectional view showing an electric rotary machine according to a first embodiment.

FIG. 2 is a schematic cross-sectional view showing an electric rotary machine according to a second embodiment.

### DESCRIPTION OF THE EMBODIMENTS

In the description and claims, the terms “external” and “internal” as well as “axial” and “radial” orientations will be used to designate, according to the definitions given in the description, elements of the electric rotary machine. By convention, the axis X of rotation of the rotor of the rotating electric machine defines the “axial” orientation. The “radial” orientation is directed orthogonally to the axis X and, from the inside towards the outside moving away from said axis X.

The electric rotary machine 1 is designed to equip a motor vehicle. The electric rotary machine 1 can be used as a motor to propel an electric or hybrid vehicle and/or as a generator for such a vehicle. The electric rotary machine 1 can also be used in a motor vehicle with a thermal engine. In such circumstance, the electric rotary machine 1 can be an alternator configured to transform the mechanical energy coming from the thermal engine into electric energy with the aim of recharging the vehicle battery and electrically supplying the vehicle's on-board network or an alternator-starter which further has an additional mode of operation in which it transforms electric energy into mechanical energy to start the thermal engine of the motor vehicle.

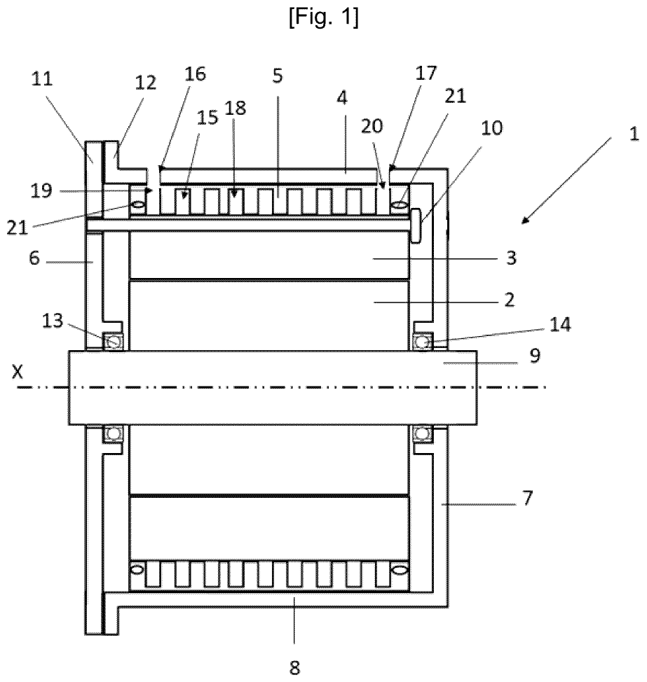

As shown in FIG. 1, the electric rotary machine 1 comprises a rotor 2, a stator 3 and a casing 4 in which the rotor 2 and the stator 3 are enclosed. The casing 4 has a general shape of a cylinder of revolution and includes two opposing disc-shaped faces 6, 7 joined together by a cylindrical skirt 8. The casing 4 includes at least two components which are attached to each other. In the illustrated embodiment, the two components each comprise a flanged end 11, 12, the flanged ends of the two components being attached to each other, for instance by means of bolts, not shown.

The rotor 2 is rotatably mounted on the casing 4 around the rotation axis X. For that purpose, the rotor 2 is non-rotatably connected to a rotor shaft 9 which is rotatably mounted on the casing 4 along the X axis. In the embodiment of FIG. 1, the rotor shaft 9 is rotatably guided on the casing 4 by means of a pair of bearings 13, 14. Besides, the rotor shaft 9 passes through at least one hole arranged in one of the disc-shaped faces 6 of the casing 4 to be coupled to another transmission component.

The stator 3 radially surrounds the rotor 2. The stator 3 includes an iron core which carries windings. The iron core is formed with a plurality of groove in the inside of which the windings are inserted. The iron core comprises for instance a plurality of plate, such as electrical steel plate, which are layered and caulked to each other to form a laminate.

Stator 3 is bolted to one of the two opposing faces 6 of the casing 4 by means of screws 10, one of which is shown in FIG. 1. The screws 10 run parallel to the X axis and each pass through a corresponding hole arranged in the stator 3 and more especially in its iron core.

Besides, a stator sleeve 5 is radially interposed between an outer surface of the stator 3 and an inner cylindrical surface of the casing 4. In other words, the stator sleeve 5 comprises a radially outer surface that contacts the cylindrical skirt of the housing and a radially inner surface that contacts an outer cylindrical surface of the stator 3.

As it will be described below, the stator sleeve 5 has both heat-dissipation and vibrations dampening functions.

The stator sleeve 5 comprises a cooling groove 15 which is arranged on the radially inner surface of the stator sleeve 5. The cooling groove 15 is helicoidal around the X axis. As shown in FIG. 1, when the stator sleeve 5 is fitted to the outside of the stator 3, the opening of the cooling groove 15 is blocked by the radially outer surface of the stator 3. Therefore, a flow path 18 having a spiral shape is formed between the radially inner surface of the stator sleeve 5 and the outer surface of the stator 3. Such arrangement has better heat dissipation performance than according to the prior art, i.e., when the cooling groove 15 was provided between the inner cylindrical surface of the casing 4 and the radially outer surface of the stator sleeve 5.

Besides, the flow path 18 is intended to be connected, on the one hand, to a coolant supply line To that end, the casing 4 comprises a supply port 16, i.e., a hole for supplying the coolant to the cooling groove 15. The supply port 16 communicates with a first end of the cooling groove 15 through a first opening 19 formed in the stator sleeve 5.

The coolant is a dielectric fluid, such as oil, which allows the coolant to be directly in contact with the iron core of the stator 3.

Moreover, according to a non-illustrated embodiment, the iron core further comprises a plurality of ducts which are arranged to conduct the coolant from the cooling groove 15 to the windings of the stator 3.

The casing 4 comprises at least one discharge port 17, i.e., a hole for discharging the coolant flowing in the casing 4.

The stator sleeve 5 is made of an elastic material and has therefore vibrations dampening properties. The stator sleeve 5 is therefore arranged to filter the vibrations of the stator 3 resulting from the electromagnetic forces present in the stator 3 when it is in operation. Thus, the stator sleeve 5 limits the propagation of vibrations from the stator 3 towards the casing 4 of the electric rotary machine 1 to reduce the magnetic noise of the electric rotary machine 1.

The stator sleeve 5 is made of a material having a young modulus which is comprised between 0.001 and 0.1 GPa.

The stator sleeve 5 is advantageously made of an elastomeric material, such as rubber.

In the embodiment of FIG. 1, the stator sleeve 5 further includes metallic inserts 21 which are embedded in the elastomeric material. Such metallic inserts 21 can be used to increase stiffness of the stator sleeve 5 and/or ensure its tightness if required.

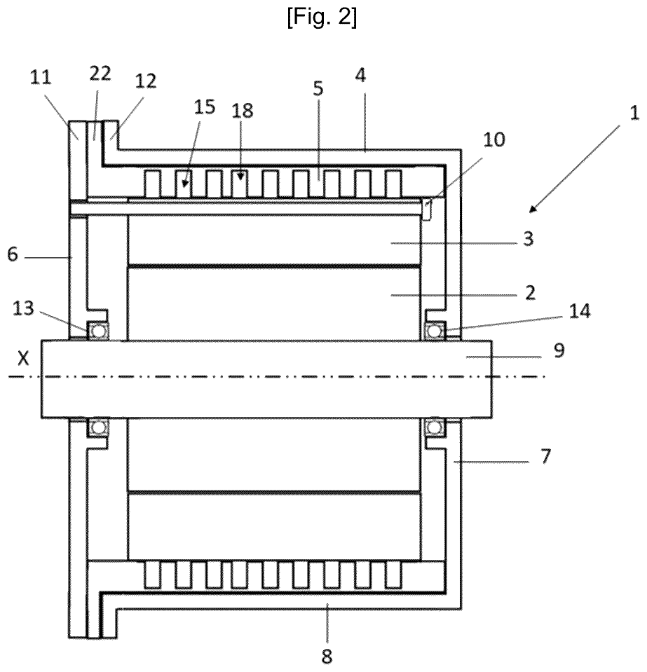

FIG. 2 illustrates an electric rotary machine according to a second embodiment. This second embodiment differs from the first embodiment described above in relation with FIG. 1 in that the stator sleeve 5 is pressed against at least one of the disc-shaped faces 7, 8 of the casing 4 and advantageously the two disc-shaped faces 7, 8 of the casing 4. Moreover, the stator sleeve 5 also comprises a radial flange 22 which is axially interposed between the two flanged ends 11, 12 of the two components of the casing 4 which are attached to each other. Such features further improve vibrations dampening performance of the stator sleeve 5.

Although the invention has been described in connection with several embodiments, it is very clear that it is in no way limited thereto and that it comprises all the technical equivalents of the means described as well as their combinations, if these fall within the scope of the invention as claimed.

The use of the verb “have”, “comprise” or “include” and its conjugated forms does not exclude the presence of elements or steps other than those mentioned in a claim.

In the claims, any reference in parentheses should not be interpreted as a limitation of the claim.

1. Electric rotary machine for an automotive vehicle comprising:
a rotor which is non-rotatably connected to a rotor shaft,
a stator which surrounds the rotor;
a casing in which the rotor and the stator are enclosed, the rotor shaft being rotatably mounted on the casing along an X axis; and
a stator sleeve which is enclosed in the casing and is radially arranged between an outer surface of the stator and an inner cylindrical surface of the casing; the electric rotary machine being wherein the stator sleeve is made of an elastic material and is arranged to filter vibrations which are generated by the stator and result from electromagnetic forces present in the stator when the electric rotary machine is in operation and in that the stator sleeve comprises a cooling groove which is intended to be connected to a coolant supply line.

2. Electric rotary machine according to claim 1, wherein the cooling groove is helicoidal around the X axis and is arranged on a radially inner surface of the stator sleeve so that a flow path having a spiral shape is formed between the radially inner surface of the stator sleeve and the outer surface of the stator.

3. Electric rotary machine according to claim 1, wherein the casing comprises a supply port which communicates with a first end of the cooling groove.

4. Electric rotary machine according to claim 1, wherein the coolant supply line is filled with a coolant which is a dielectric fluid, such as oil.

5. Electric rotary machine according to claim 1, wherein the elastic material is an elastomeric material.

6. Electric rotary machine according to claim 1, wherein the elastic material has a young modulus which is comprised between 0.001 and 0.1 GPa.

7. Electric rotary machine according to claim 1, wherein the casing includes two opposing faces which are orthogonal to the X axis and are joined together by a cylindrical skirt which extends around the X axis.

8. Electric rotary machine according to claim 7, wherein the stator is bolted to the one of the two opposing faces of the casing by means of screws which extend parallel to the X axis and each pass through a corresponding hole arranged in the stator.

9. Electric rotary machine according to claim 7, wherein the stator sleeve is pressed against at least one of the opposing faces of the casing.

10. Electric rotary machine according to claim 7, wherein the casing includes at least two components which each comprise a flanged end, the flanged ends of the two components being attached to each other and wherein the stator sleeve comprises a radial flange which is axially arranged between the two flanged ends.

11. Electric rotary machine according to claim 2, wherein the stator sleeve includes metallic inserts which are embedded in the elastic material.

12. Electric rotary machine according to claim 1, wherein the stator comprises windings and an iron core which carries the windings.

13. Electric rotary machine according to claim 12, wherein the iron core comprises a plurality of ducts which are arranged to conduct the coolant from the cooling groove to the windings.

14. Automotive vehicle comprising an electric rotary machine according to claim 1.

15. Electric rotary machine according to claim 2, wherein the casing comprises a supply port which communicates with a first end of the cooling groove.

16. Electric rotary machine according to claim 2, wherein the coolant supply line is filled with a coolant which is a dielectric fluid, such as oil.

17. Electric rotary machine according to claim 2, wherein the elastic material is an elastomeric material.

18. Electric rotary machine according to claim 2, wherein the elastic material has a young modulus which is comprised between 0.001 and 0.1 GPa.

19. Electric rotary machine according to claim 2, wherein the casing includes two opposing faces which are orthogonal to the X axis and are joined together by a cylindrical skirt which extends around the X axis.

20. Electric rotary machine according to claim 8, wherein the stator sleeve is pressed against at least one of the opposing faces of the casing.
